(19) United States
(12) Patent Application Publication
(10) Pub. No.: US 2024/0303095 A1
(43) Pub. Date: Sep. 12, 2024

(54) SCREEN CREATION DEVICE AND COMPUTER-READABLE STORAGE MEDIUM

(71) Applicant: FANUC CORPORATION, Yamanashi (JP)

(72) Inventor: Shinichi OZEKI, Yamanashi (JP)

(21) Appl. No.: 18/578,699

(22) PCT Filed: Jul. 21, 2021
(86) PCT No.: PCT/JP2021/027370

§ 371 Date: Jan. 11, 2024

(51) Int. Cl. G06F 9/451; G05B 19/409

(52) U.S. Cl. CPC G06F 9/451; G05B 19/409

(57) ABSTRACT

This screen creation device for assisting in creation of a user interface screen of a numerical value control device stores components that are arranged on the user interface screen and composite components obtained by combining components, acquires mechanical information about a machine tool to be controlled by the numerical value control device, stores the mechanical information, the composite components, and creation rules for the user interface screen in association with one another, determines whether the user interface screen being created complies with the creation rules associated with the mechanical information about the machine tool to be controlled, and notifies the user of the user interface screen not complying with the creation rules.

### RELATED APPLICATION

The present application is a National Phase of International Application No. PCT/JP2021/027370 filed Jul. 21, 2021.

### TECHNICAL FIELD

The present invention relates to a window creation device and a computer-readable storage medium.

### BACKGROUND ART

A numerical controller is a machine for controlling a machine tool. The numerical controller is provided with a user interface window (referred to as a UI window). The UI window displays the state of the machine tool and accepts input from an operator.

A control target of the numerical controller may be, for example, a turning machine, a drilling machine, a boring machine, a milling machine, a grinding machine, a machining center, a turning center, an electric discharge machine, or the like. A developer of the UI window creates a UI window in accordance with a type of a machine tool, a machine configuration of the machine tool, and a user requirement specification.

For example, FIG. 3 of Patent Literature 1 is a display window example of a spindle load. This window displays the state of a machine tool “automatic drive”, the current time “2002/4/23 21:53:40”, a graph of the spindle load, a program being executed, and window operation buttons.

Conventionally, there is dedicated software for creating a UI window of the numerical controller. This software provides components for window creation. The developer of the UI window arranges these components on the UI window and sets properties (attribute or operation contents (execution function)) of individual components to complete the UI window.

### CITATION LIST

### Patent Literature

Patent Literature 1: Japanese Patent Application Laid-Open No. 2004-126956

### SUMMARY OF INVENTION

### Technical Problem

When there is wrong use of components in creating the UI window of the machine tool, this may be detected in final debugging. When a problem is found in a downstream step, the UI window required to be recreated, which is troublesome.

In the field of numerical controllers, there is a demand for a technology of simplifying creation of a user interface.

### Solution to Problem

A window creation device that is one aspect of the present disclosure is a window creation device that supports creation of a user interface window f a numerical controller, the window creation device includes: a component library that stores at least one component to be arranged in the user interface window and a composite component combining a plurality of components; a machine information acquisition unit that acquires machine information on a machine tool that is a control target of the numerical controller; a rule storage unit that stores the machine information, the composite component, and a rule for the creation of the user interface window in association with each other; and a rule determination unit that determines whether or not the user interface window being created conforms to the rule associated with the machine information on the machine tool, and the window creation device notifies the user that the user interface window does not conform to the rule.

A computer-readable storage medium that is one aspect of the present disclosure stores a instruction configured to: when executed by one or a plurality of processors, store at least one component to be arranged in a user interface window and a composite component combining a plurality of components; acquire machine information on machine tool of the numerical controller that displays the user interface window; store the machine information, the composite component, and a rule for the creation of the user interface window in association with each other; determine whether or not the user interface window being created conforms to a rule associated with the machine information on the machine tool; and notify a user that the user interface window does not conform to the rule.

### Advantageous Effects of Invention

According to one aspect of the present invention, creation of a user interface can be simplified.

### BRIEF DESCRIPTION OF DRAWINGS

FIG. 1 is a diagram illustrating a relationship between a window creation device and a numerical controller.

FIG. 2 is a block diagram of the window creation device.

FIG. 3 is a diagram illustrating an example of a UI editing window.

FIG. 4 is a diagram illustrating a relationship between a composite component and individual components.

FIG. 5 is a diagram illustrating an example of a UI window in which a composite component is arranged.

FIG. 6 is an example in which two or more composite components are arranged superimposed in a single display region.

FIG. 7 is a diagram illustrating an example of classification of machines.

FIG. 8 is a diagram illustrating an example of rules of composite components.

FIG. 9 is a diagram illustrating a relationship between a depending composite component and a depended composite component.

FIG. 10 is an example of a workpiece coordinate table component.

FIG. 11 is a diagram illustrating a difference in functions used for calculating workpiece coordinates.

FIG. 12 is a diagram illustrating an example in which a required function differs for each machine condition.

FIG. 13 is a diagram illustrating a method of setting workpiece coordinates of a wire cutting electric discharge machine.

FIG. 14 is a schematic diagram illustrating the operation of a rule determination unit.

FIG. 15 is a flowchart illustrating the operation of the window creation device.

FIG. 16 is a diagram illustrating a hardware configuration of the window creation device.

### DESCRIPTION OF EMBODIMENTS

A window creation device 100 will be described below.

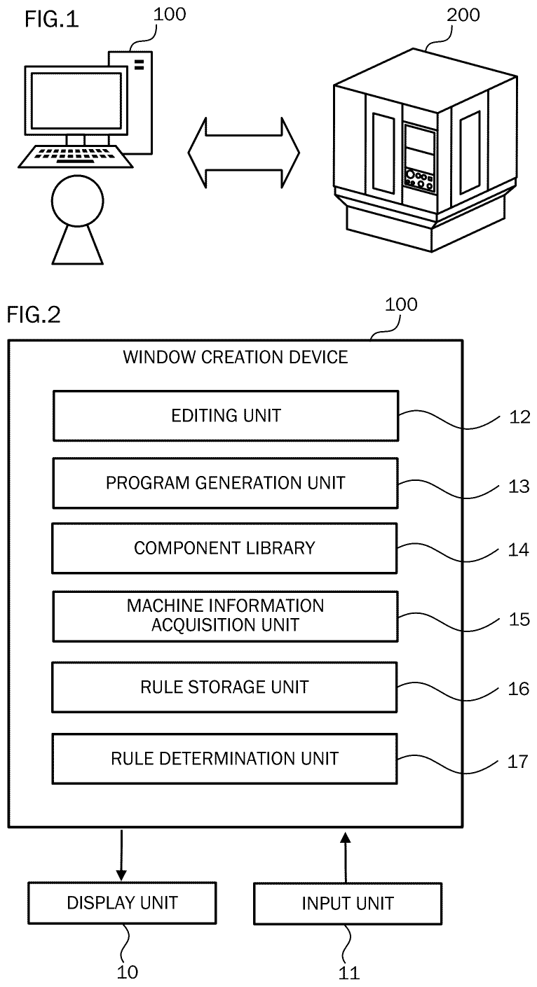

As illustrated in FIG. 1, the window creation device 100 is implemented in an information processing device such as a personal computer (PC). Dedicated software for creating an operation window of a numerical controller 200 is installed in the window creation device 100. A user operates the software to create a UI window. The UI window created by using the dedicated software is transferred to the numerical controller 200 and then displayed on a display unit 10 of the numerical controller 200.

FIG. 2 is a block diagram of the window creation device 100. The window creation device 100 includes a display unit 10, an input unit 11, an editing unit 12, a program generation unit 13, a component library 14, a machine information acquisition unit 15, a rule storage unit 16, and a rule determination unit 17.

The editing unit 12 displays a UI editing window 20 on the display unit 10 of the window creation device 100 and accepts an editing operation from the user. The editing unit 12 updates window arrangement or component properties (attributes) in accordance with input operations by the user.

The program generation unit 13 converts the UI window arrangement or component properties created in the editing unit 12 into an executable program. The executable program is implemented in the numerical controller 200 to function as a UI window.

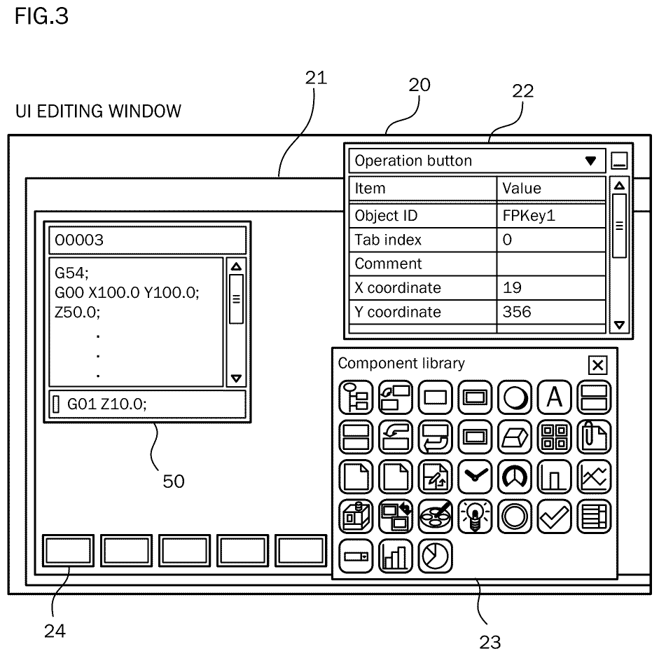

FIG. 3 is an example of the UI editing window 20. The UI editing window 20 is formed of a UI editing region 21, a property display region 22, and a component library display region 23. A component that can be arranged in the UI window can be selected from the component library display region 23. Five components (operation buttons 24) are arranged in the UI editing region 21. One of four components is in a selected state. Properties of the selected components are displayed on the property display region 22.

In the property display region 22, information related to the component can be set that may be visual information such as a size, a shape, and coordinates of the component, a label such as a numerical value, an icon, and a character string, a type of a component, a name of a component, an operation detail (execution function) for the component, or the like.

The component library 14 stores the component of the UI window. The component includes an individual component and a composite component 50. The individual component is an independent component. The individual component may be an operation button 24, a key input button, a label, or the like but is not limited thereto.

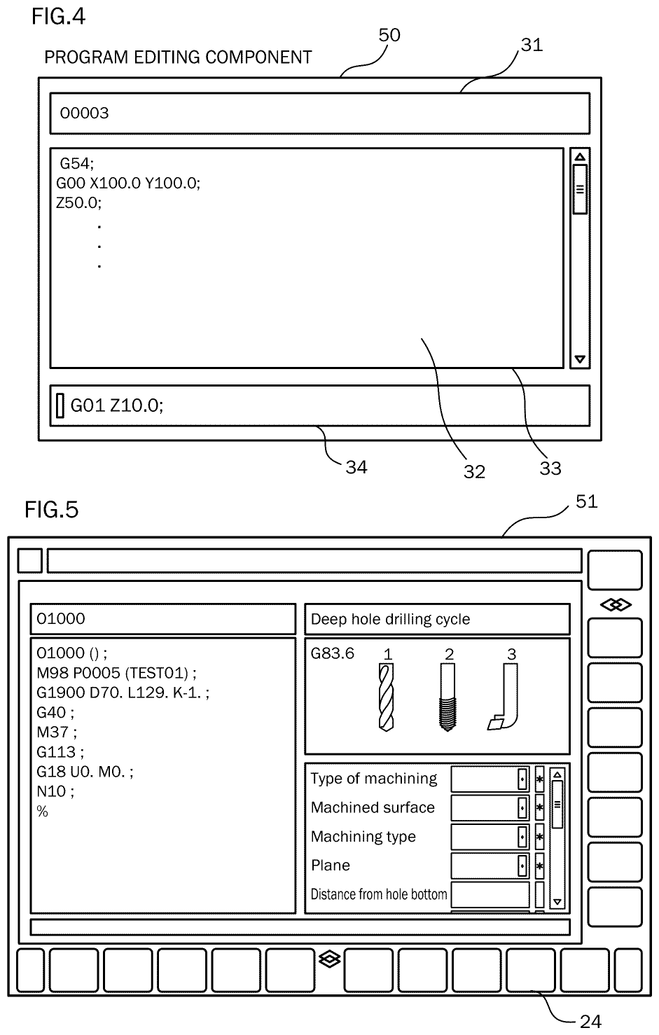

The composite component 50 is a component combining the plurality of individual components. The composite component 50 (a program editing component) in FIG. 4 is formed of the plurality of individual components (a label display component 31, a figure display component 32, a multiline character string display component 33, and an input accepting component 34). The label display component 31 is a component for displaying a character string. Herein, a program name “00003” is displayed. The figure display component 32 is a component used for window design. Herein, a blue background is used. The multiline character string display component 33 is a component for displaying a plurality of character strings. Herein, a machining program is displayed in the multiline character string display component 33. The input accepting component 34 accepts input of a character string to be edited. When “Enter” key is pressed, the character string that has been input to the input accepting component 34 is reflected in the multiline character string display component 33.

A UI window will be described with reference to FIG. 5 in which the composite component 50 is already arranged. A base component 51 and the composite component 50 are arranged in the UI editing region 21 of FIG. 5. As illustrated in FIG. 5, the operation buttons 24 for operating the UI window are aligned in the lower and right regions of the base component 51. The composite component 50 and an individual component can be arranged in the center region of the base component 51.

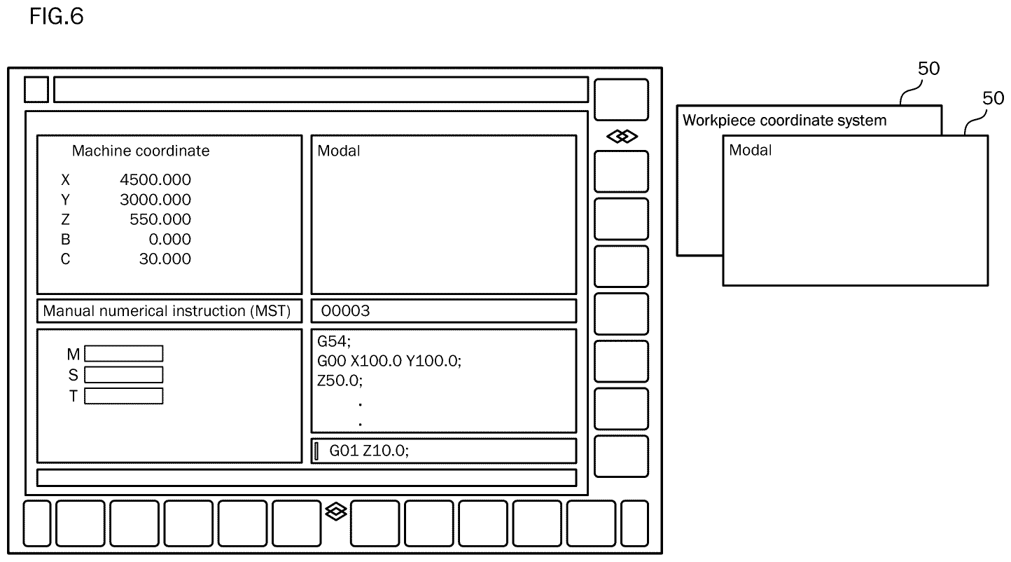

As illustrated in FIG. 6, two or more composite components 50 may be arranged superimposed in a single display region of the UI window. When one of the arranged composite components 50 in a superimposed manner is displayed, the remaining composite components 50 are hidden.

The machine information acquisition unit 15 acquires machine information on the machine tool. The machine information may be directly input to the window creation device 100 by the user or may be determined from parameters or option information set in the numerical controller 200.

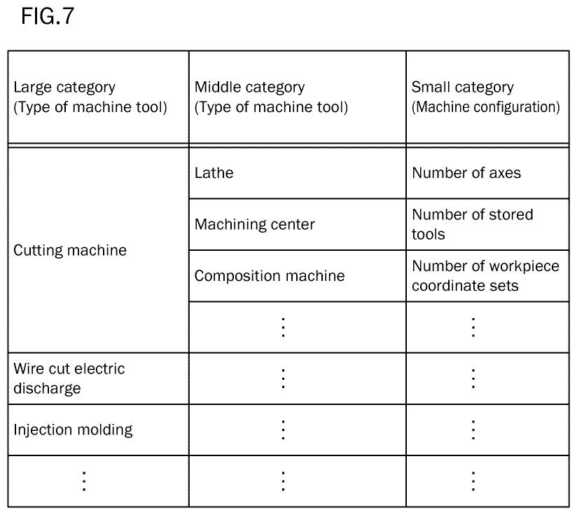

The rule storage unit 16 stores a rule for each composite component 50. The rule is associated with the composite component 50 and machine information. The machine information is information indicating characteristics of a machine tool such as a type of a machine tool and a machine configuration of a machine tool. The machine information can be classified as with a table of FIG. 7, for example. In FIG. 7, machine tools are classified into “large category”, “middle category”, and “small category”. The “large category” and “middle category” are categories in accordance with the type of a machine tool. Examples of the “large category” include “cutting machine”, “wire cut electric discharge machine”, “injection molding”, or the like. The “middle category” is a more detailed category than the “large category”. The large category “cutting machine” of FIG. 7 is divided into items such as the middle categories “lathe”, “machining center”, “composition machining machine”, or the like. The “small category” is subdivided from the “middle category” in accordance with the machine configuration. The “small category” includes items such as “the number of axes”, “the number of stored tools”, “the number of workpiece coordinate sets”, or the like.

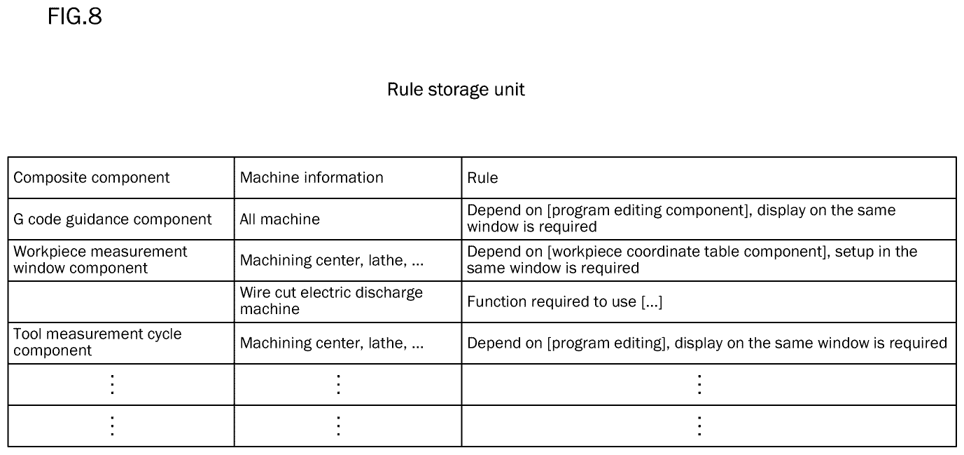

The rule storage unit 16 associates the composite component 50, the machine information, and the rule with each other. FIG. 8 is an example of the rule storage unit 16. An example of rules stored in the rule storage unit 16 will be described below. In the following description, a rule for the composite component 50 and a rule for the function will be described, but the rules are not limited thereto.

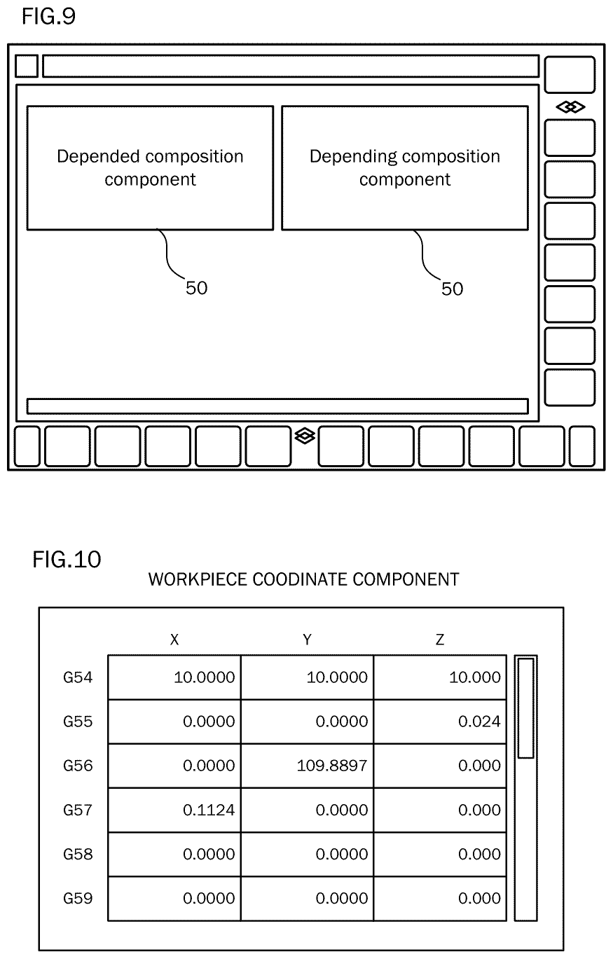

The rule for the composite component 50 defines a usable composite component 50, a dependence relationship between the composite component 50 and other composite components 50, or the like for each piece of machine information. The dependence relationship means that, unless one of the composite components 50 (depended composite component) is arranged in the UI window, the other composite component 50 (depending composite component) will not function. Some dependence relationships may require for these composite components to be displayed on the same window (see FIG. 9), and other dependence relationships may require for these composite components to be set on the same window (see FIG. 6).

The rule for a function defines a type of functions for composite component 50 such as a usable function, a function required to be used, a function prohibited from being used at the same time, or the like. The defines of the rule is not limited thereto. The defines differ even for the same composite component 50 depending on each piece of machine information.

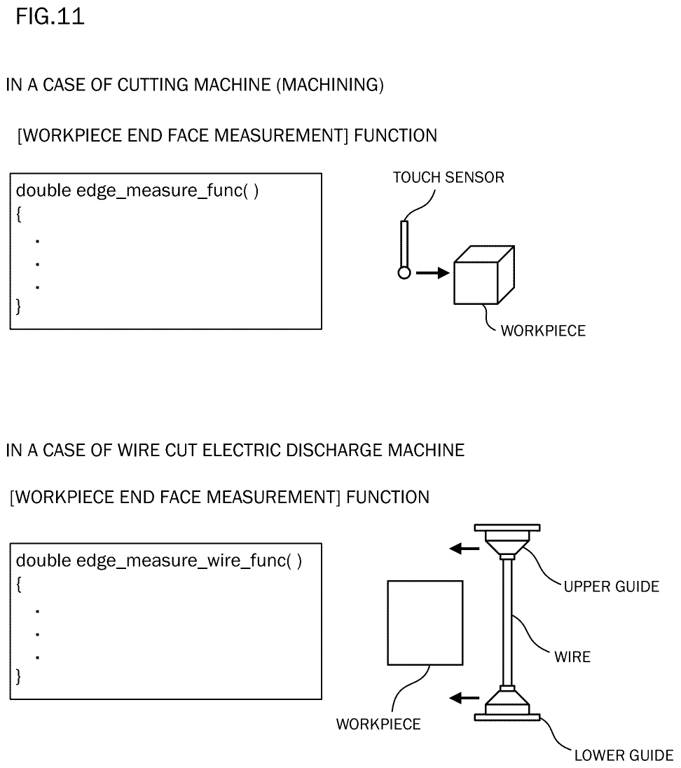

FIG. 10 and FIG. 11 show an example in which usable functions differ for each piece of machine information even for the same composite component 50. FIG. 10 shows the workpiece coordinate table component in which accepts setting of workpiece coordinates. The workpiece coordinate table component provides functions suitable for the cutting machine (machining machine and the wire cut electric discharge machine because respective machine tools use different methods for calculating the origin (workpiece origin) of workpiece coordinates (see FIG. 11).

In the cutting machine, function “double edge_measure_func( )” sets the workpiece origin in the workpiece coordinate table by measuring the end face of the workpiece with a touch sensor, reading the coordinates of a contact point.

In the wire cut electric discharge machine, it is required to vertically align the “upper guide” and “lower guide” of the wire and cause these guides to operate at the same time and at the same speed. A function “double edge_measure_wire_func( )” sets the workpiece origin in the workpiece coordinate table by contacting the end face of the workpiece with the wire and reading the coordinates of a contact point.

In such a way, even with the same composite component 50, the usable function differs in accordance with machine information. The rule storage unit 16 stores such function rules for each piece of machine information.

Even with the same composite component 50, the required function may also differ for each machine condition.

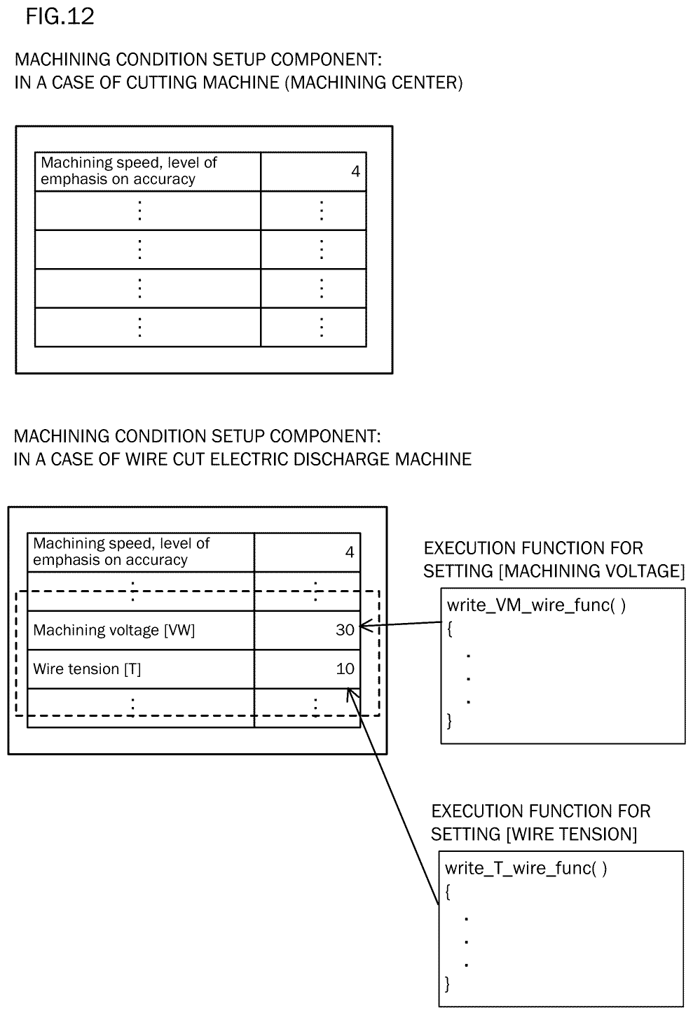

In an example of FIG. 12, items in machining condition setup component are different for cutting machine and the wire cut electric discharge machine. There is an additional item for the wire cut electric discharge machining.

The machining condition setup components can be used commonly to the cutting machine and the wire cut electric discharge machine. However, there is an additional required item for the wire cut electric discharge machine. When the required item is not set, this will result in an insufficient setup and cause the operation to be inoperable. Functions “write_VM_wire_func( )” for setting “machining voltage” and a function “write_T_wire_func( )” for setting “wire tension” are required to be added to the machine condition of the wire cut electric discharge machine.

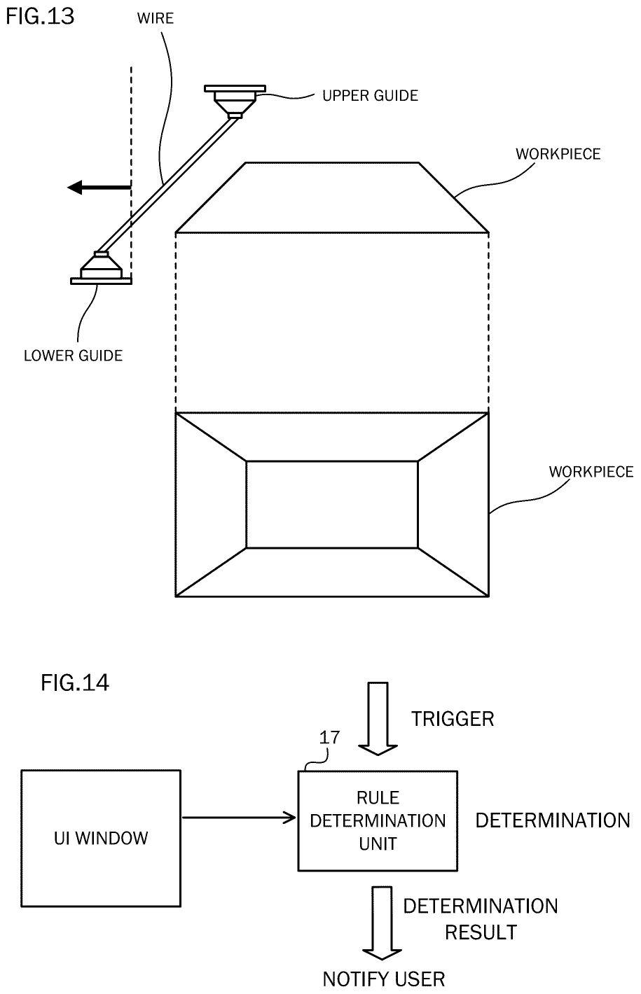

U-axis and V-axis are also additional items for a wire cut electric discharge machine for setting workpiece coordinates. As illustrated in FIG. 13, by controlling the U-axis and V-axis of an upper nozzle, the wire cut electric discharge machine can perform taper machining (forming a plus/minus slope shape over the whole circumference or partially) or vertically heteromorphic machining (in which shapes of the upper face and the lower face differ from each other). Setups of the U-axis and the V-axis correspond to the required items specific to a wire cut electric discharge machine but do not correspond to the required items for other machine tools.

The rule storage unit 16 stores such differences in rules for each piece of machine information.

The rule determination unit 17 determines whether or not the UI window being created conforms to the rule. FIG. 14 is a schematic diagram illustrating the operation of the rule determination unit 17. The rule determination unit 17 starts determination in response to a trigger. The rule determination unit 17 determines whether or not the UI window conforms to the rule and notifies the user of the determination result. The trigger to start determination is not particularly limited. The follows may be used as a trigger: addition of a new element such as arrangement of a new composite component 50 or a setup of a new function; a user instruction to start determination; completion of creation work of the UI window; or an internal signal of the numerical controller 200.

The rule storage unit 16 may store a scenario in which a rule is updated in accordance with an event such as user input or a signal from the machine tool. For example, in response to setting of a function, an item associated with the function is defined as a requirement, or a set up or use of another function contrary to the function is defined as being against the rule.

The rule determination unit 17 determines whether or not the UI window being created conforms to the rule, and when the UI window being created does not conform to the rule, the rule determination unit 17 notifies the user of the fact. The notification means may be alert display, message display, icon display, or the like but is not limited thereto.

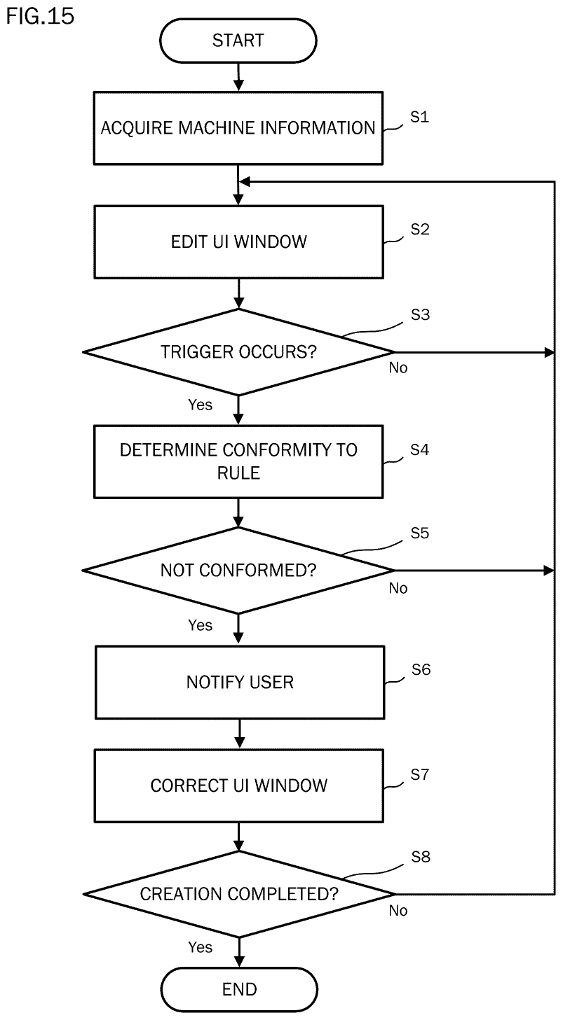

FIG. 15 is a flowchart illustrating the operation of the window creation device 100 of the present disclosure. The window creation device 100 acquires machine information on the machine tool controlled by the numerical controller 200 (step S1). The user edits the UI window (step S2). In creation of the UI window, arrangement of an individual component, arrangement of a composite component, setup of a function, setup of a parameter, or the like are performed. Note that the order of step S1 and step S2 may be reversed.

If a trigger to start rule determination occurs (step S3; Yes), the window creation device 100 determines whether or not a rule associated with the machine information acquired in step S1 and the composite component 50 arranged in the UI window conforms to the UI window being created (step S4). Note that the follows may be the trigger of step S4; the addition of a new element such as arrangement of a new composite component 50 or setup of a new function; a user instruction to start determination; completion of the creation work of the UI window; an internal signal of the numerical controller 200. In step S3, if no trigger to start the rule determination occurs (step S3; No), the process returns to an editing window of the UI window (step S2).

In the UI window being edited, if nonconformity to the rule is detected (step S5; Yes), the window creation device 100 notifies the user of the presence of nonconformity. Further, the window creation device 100 may notify the user of a portion where the nonconformity is present (step S6).

In step S5, if no nonconformity is detected (step S5; No), the window creation device 100 proceeds with the process to step S2 and continues the creation of the UI window.

The user verifies nonconformity to the rule and corrects the UI window (step S7). Note that determination of nonconformity to the rule may be performed one or more times during correction work. After the correction of the UI window, if the creation of the UI window ends (step S8; Yes), the process ends.

After the correction of the UI window, if the creation of the UI window is continued (step S8; No), the window creation device 100 proceeds with the process to step S2, and the creation of the UI window is continued.

As described above, the window creation device 100 of the present disclosure stores the composite component 50, the machine information, and the rule of window creation in association with each other. The window creation device 100 determines whether or not the UI window being created complies with the rule corresponding to the machine tool that is the control target, and when the UI window does not comply with the rule, notifies the user that the UI window does not conform to the rule.

The composite component 50 is not a mere component but has a meaning in accordance with the purpose of use. Thus, it is possible to determine which composite component 50 is usable, whether a function to be used, what type of individual component is required, or the like depending on each piece of machine information.

Detection inconsistency in final debugging will involve burdensome correction work for creation of a UI window. By associating machine information, the composite component 50, and the rule with each other, the window creation device 100 of the present disclosure can create a UI window adapted to a type of a machine tool or a machine configuration and reduce the burden of correction work, and the creation of the UI window is simplified.

### [Hardware Configuration]

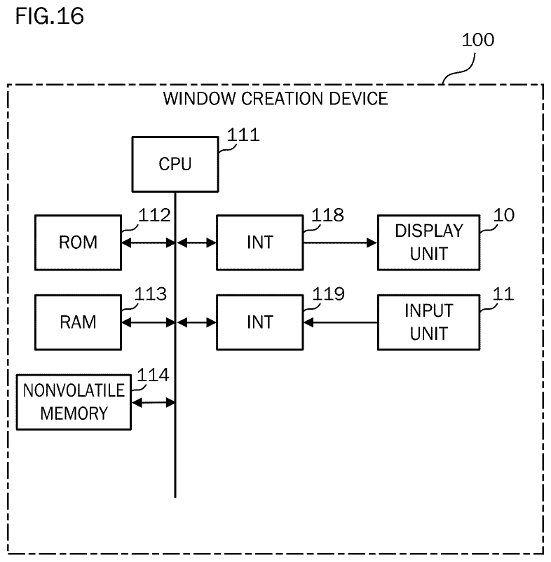

FIG. 16 shows a hardware configuration of the window creation device 100 of the present disclosure.

The hardware configuration of the window creation device 100 will be described with reference to FIG. 16. A CPU 111 included in the window creation device 100 is a processor that controls the numerical controller 200 as a whole. The CPU 111 loads a system program into a ROM 112 via a bus and controls the overall window creation device 100 in accordance with the system program. A RAM 113 temporarily stores temporal calculation data or display data, various data input by a user via an input unit 11, or the like.

A display unit 10 is a monitor or the like attached to the window creation device 100. The display unit 10 displays an operation window, a setup window, or the like of the window creation device 100.

The input unit 11 is a keyboard, a touch panel, or the like integrated with the display unit 10 or separated from the display unit 10. The user may operate the input unit 11 to perform entry to a window displayed or the like in the display unit 10. Note that the display unit 10 and the input unit 11 may come with a mobile terminal.

A nonvolatile memory 114 is a memory that is backed up by a battery (not illustrated) or the like, for example, and that can retain stored information even when the window creation device 100 is powered off. The nonvolatile memory 114 stores a program loaded from an external device via an interface (not illustrated) or a program input via the input unit 11 or various data acquired from each unit of the window creation device 100, the machine tool, or the like (for example, setup parameters or the like acquired from the machine tool). The program or various data stored in the nonvolatile memory 114 may be loaded into the RAM 113 when executed or used. Further, various system programs are written in the ROM 112 in advance.

1. A window creation device that supports creation of a user interface window of a numerical controller, the window creation device comprising:
a component library that stores at least one component to be arranged in the user interface window and a composite component combining a plurality of components;
a machine information acquisition unit that acquires machine information on a machine tool that is a control target of the numerical controller;
a rule storage unit that stores the machine information, the composite component, and a rule for the creation of the user interface window in association with each other; and
a rule determination unit that determines whether or not the user interface window being created conforms to the rule associated with the machine information on the machine tool,
wherein the window creation device notifies the user that the user interface window does not conform to the rule.

2. The window creation device according to claim 1, wherein the rule storage unit stores the rule that defines a usable composite component and a dependence relationship of the composite component for each piece of the machine information for the creation of the user interface window.

3. The window creation device according to claim 1, wherein the rule storage unit stores the rule that defines a usable function in the composite component for each piece of the machine information for the creation of the user interface window.

4. The window creation device according to claim 1, wherein the rule storage unit stores the rule that defines a function required to be used in the composite component for each piece of the machine information for the creation of the user interface window.

5. A computer-readable storage medium storing a instruction configured to: when executed by one or a plurality of processors,
store at least one component to be arranged in a user interface window and a composite component combining a plurality of components;
acquire machine information on machine tool of the numerical controller that displays the user interface window;
store the machine information, the composite component, and a rule for the creation of the user interface window in association with each other;
determine whether or not the user interface window being created conforms to a rule associated with the machine information on the machine tool; and
notify a user that the user interface window does not conform to the rule.
